(19) United States
(12) Patent Application Publication
(10) Pub. No.: US 2016/0298993 A1
(43) Pub. Date: Oct. 13, 2016

(54) MEASURING AND DISPENSING DEVICES AND METHODS FOR MEASURING AND DISPENSING MATERIALS

(71) Applicant: Aaron Lee Bernard, Wilmington, DE (US)

(72) Inventor: Aaron Lee Bernard, Wilmington, DE (US)

(21) Appl. No.: 15/092,980

(22) Filed: Apr. 7, 2016

Related U.S. Application Data
(60) Provisional application No. 62/178,306, filed on Apr. 7, 2015.

(51) Int. Cl. G01F 11/40; G01F 11/38; G01F 19/00

(52) U.S. Cl. CPC G01F 11/40; G01F 19/00; G01F 11/38

(57) ABSTRACT

The present disclosure provides devices and methods for measuring and dispensing material from containers. Such materials include dry goods such as foodstuffs, agricultural materials and other dry materials that are used. Other materials including liquids can also be measured and dispensed. The devices and methods can help to prevent product spoilage and limit exposure of products to the environment and contamination. In addition, accurate and reproducible measurement of materials can be achieved.

### CROSS REFERENCE TO RELATED APPLICATIONS

The present application claims priority to U.S. Provisional Application No. 62/178,306 filed Apr. 7, 2015, which is incorporated herein by reference in its entirety.

### SUMMARY

Food safety and protection is a concern throughout the world. In the case of dry goods, exposure to the environment, contamination and spoilage are issues which result in waste and illness. In addition, portion control is an issue for health-related reasons, for example, in dieting or managing disease through diet, and in situations where rationing is employed. In circumstances where portion control is desired, it is important to have a suitable device and method for measuring and dispensing the proper amount of product accurately and reproducibly while minimizing risks from environmental exposure, contamination and spoilage.

Environmental exposure, contamination and spoilage are also issues for other types of materials such as agricultural and household products. Accurate and reproducible measurement and dispensing of these materials is likewise important.

Improved devices and methods for measuring and dispensing materials would be helpful to address the above risks and needs. The present disclosure accomplishes these and other objectives by providing systems, devices and methods for accurate and/or reproducible measurement and dispensing of materials while minimizing the risks from environmental exposure, contamination and spoilage.

### BRIEF DESCRIPTION OF THE DRAWINGS

FIG. 1 depicts a perspective view of a device according to an embodiment of the present invention.

FIG. 2 depicts a perspective view of a device according to an embodiment of the present invention.

FIG. 3 depicts the device shown in FIG. 1 with a container attached thereto.

FIG. 4 depicts the device shown in FIG. 3 with the container attached thereto and in an inverted position.

FIG. 5 depicts the device shown in FIG. 2 with a container attached thereto.

FIG. 6 depicts the device shown in FIG. 5 with the container attached thereto and in an inverted position.

FIG. 7 depicts the device shown in FIG. 6 with two graduations on a measuring compartment.

FIG. 8 depicts the device shown in FIG. 4 on a stand having vertical support struts connected to a platform.

FIG. 9 depicts a device according to an embodiment of the present invention, wherein the device includes a covering mechanism in the form of a slideable cover having two semi-circular portions, one fixed to a measuring compartment and one movable via a lever which allows for the measuring compartment to be sealed off from a base and a container.

FIG. 10 depicts the device shown in FIG. 1 with a lid.

FIG. 11 depicts a device according to an embodiment of the present invention where a circular base has a concentric, circular raised platform onto which a measuring compartment snaps-on.

FIG. 12 depicts a device according to an embodiment of the present invention attached container of oatmeal and held above a bowl of oatmeal.

FIG. 13 depicts a device of an embodiment of the present invention attached to a container of infant formula.

FIG. 14 depicts a device according to an embodiment of the present invention.

### DETAILED DESCRIPTION

Certain terminology is used in the following description for convenience only and is not limiting. Certain words used herein designate directions in the drawings to which reference is made. Unless specifically set forth herein, the terms “a,” “an” and “the” are not limited to one element, but instead should be read as meaning “at least one.” As used herein “another” means at least a second or more. The terminology includes the words noted above, derivatives thereof and words of similar import.

Unless otherwise indicated, all numbers expressing quantities of ingredients, concentrations and properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that can vary depending upon the desired properties sought to be obtained. At the very least, each numerical parameter is meant to be construed in light of the number of reported significant digits and by applying ordinary rounding techniques.

Throughout this application, the term “about” is used to indicate that a value includes the inherent variation of error for the device, the method being employed to determine the value, or the variation that exists among the study subjects.

The use of the term “or” in the claims is used to mean “and/or” unless explicitly indicated to refer to alternatives only or the alternatives are mutually exclusive.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements or method steps.

It is contemplated that any instance, embodiment, or example discussed in this specification can be implemented with respect to any method or composition of the invention, and vice versa. Furthermore, devices of the invention can be used to achieve the methods of the invention.

Devices and methods of the present disclosure can be useful for measuring and/or dispensing materials accurately and reproducibly, while limiting the risks of environmental exposure, contamination and spoilage. In one embodiment, the present disclosure is directed to devices and methods for measuring and dispensing material from containers. Such materials include, by way of example and not limitation, dry goods such as foodstuffs, agricultural materials and other dry materials that are used. The devices and methods of the present disclosure can help prevent product spoilage and limit exposure of products to the environment and contamination. The devices of the present disclosure can also help to prevent insect infestation of materials by providing a barrier between the material and the environment. In addition, accurate and reproducible measurement of materials can be achieved. The devices and methods disclosed in the present disclosure, while of particular use in the measurement and dispensing of dry goods, are likewise applicable to other materials including liquid materials such as oils, paints, and beverages.

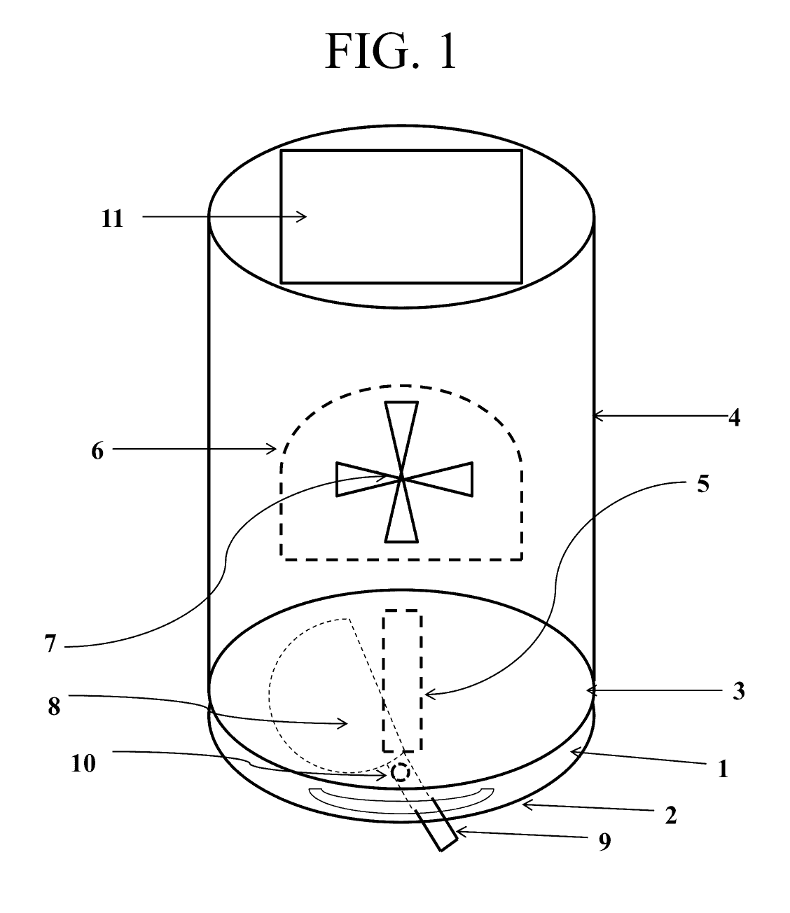

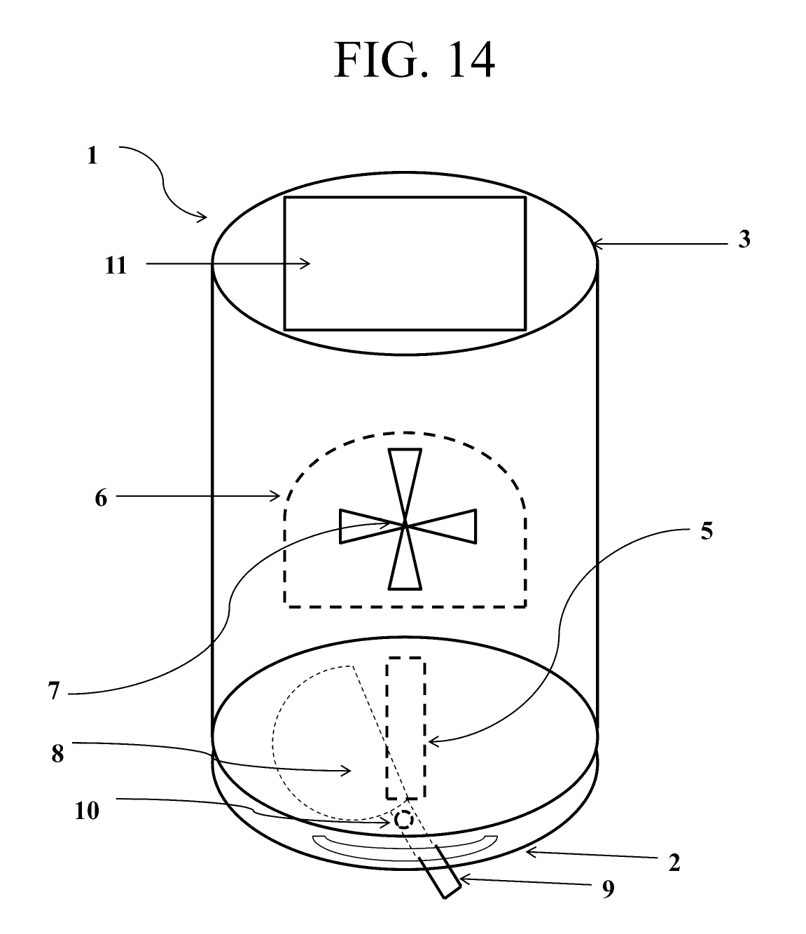

As referenced in this disclosure, certain embodiments can include a base and a body. In certain aspects, the base and the body can be considered as a single component, collectively referred to as the base as shown in FIG. 14, as compared to the distinct base and body shown in FIG. 1.

In some embodiments, a measurement device can include a base having a first end, an opposing second end, at least one aperture, and a rotating mechanism. The first end of the base can be configured to contact or receive at least a portion of a container. A measuring compartment can be rotatably connected to the base about an axis extending transverse to a vertical axis of the container. The rotating mechanism can be configured to rotate the measuring compartment. The measurement device can also include an opening and closing mechanism operatively connected to the base. The opening and closing mechanism can close the at least one aperture in a first configuration and open the at least one aperture in a second configuration.

In other embodiments, a measurement device can include a container including material therein and a base configured to receive the container at a first end. The base can be operatively connected to or contact at least a portion of a body at an opposing second end of the base. The base can include at least one aperture extending through the base. The body can include a measuring compartment and a rotating mechanism configured to rotate the measuring compartment along an axis transverse to a vertical axis of the container. The device can also include an opening and closing mechanism operatively connected to the base. The opening and closing mechanism can close the at least one aperture in a first configuration and open the at least one aperture in a second configuration.

In the foregoing embodiments, the opening and closing mechanism can permit control over the flow of material from the container through the base and into the measuring compartment. In operation, when it is desired to dispense material, the measurement devices of the foregoing embodiments can be inverted such that the container lies above the base in a vertical axis. The opening and closing mechanism can be moved from the first configuration, wherein the at least one aperture is closed, to a second configuration wherein the at least one aperture is open, thereby allowing material to flow from the container through the aperture in the base and into the measuring compartment. Once the desired quantity of material is dispensed into the measuring compartment, the opening and closing mechanism can be returned to the first configuration to stop the flow of material. Material can then be removed from the measuring compartment, which can be isolated from the container, by rotating the measuring compartment using the rotating mechanism without exposing the contents of the container to the environment or risking contamination of the material therein.

In still other embodiments, a measurement device can include a base having a first end and an opposing second end. The base can be configured to receive a container at the first end. The base can be operatively connected a measuring compartment at the opposing second end. The base can further include at least one aperture. An opening and closing mechanism can be operatively connected to the base. The opening and closing mechanism can close the at least one aperture in a first configuration and open the at least one aperture in a second configuration. The opening and closing mechanism can permit control over the flow of material from the container through the base and into the measuring compartment.

In operation, when it is desired to dispense material, the device of the foregoing still other embodiments can be inverted such that the container lies above the base in a vertical axis. The opening and closing mechanism can be moved from the first configuration, wherein the at least one aperture is closed, to a second configuration wherein the at least one aperture is open, thereby allowing material to flow from the container through the aperture in the base and into the measuring compartment. Once the desired quantity of material is dispensed into the measuring compartment, the opening and closing mechanism can be returned to the first configuration to stop the flow of material. Material can then be removed from the measuring compartment, which can be isolated from the container by detaching the measuring compartment from the base.

All of the foregoing embodiments can permit the measurement and dispensing of precise quantities of material without unnecessary exposure of the remaining material in the container to the environment. This can reduce the risk of contamination of the material because the container is not open to the air and there is no need to insert any objects into the material to measure it, such as measuring cups or spoons. Another advantage is that reproducible portions of material can be accurately controlled and waste minimized.

In certain aspects of the foregoing embodiments, the measurement device can include a lid. The lid can be attachable to the body at an end distal from the base and/or the container. By way of example, but not limitation, the lid can be attachable to the opposing second end of the base.

In certain aspects, the base is operatively connected to a measuring compartment at the second end. By way of example, but not limitation, the measuring compartment can be operatively connected to the base by being screwed into the base, snapped onto the base or adhered to the base. In some embodiments, the measuring compartment can further include at least one aperture at an end distal from said base. The at least one aperture at an end distal from the base can be covered using appropriate components including snap-on lids, screw caps, covers, lids to prevent the loss of material through the aperture when covered. Appropriate means for covering the at least one aperture at an end distal from the base can include any suitable means such as snap-on lids, screw caps, covers and lids. In certain embodiments, the measuring compartment can further include a covering mechanism that is operatively connected to the measuring compartment for sealing said measuring compartment from the base. In some embodiments, the measuring compartment and covering mechanism can be detachable from the base. By way of example, but not limitation, the measuring compartment can be detachable from the base by using a snap-on mechanism, being screwed onto the base, clamped onto or otherwise detachably connected to the base. Thus, after measuring a material into the measuring compartment, in certain embodiments, the measuring compartment can be covered by the covering mechanism to isolate it from the base and the measuring compartment and covering mechanism detached for storage, transport or use at a later time without having to transport the entire device with the container and all of the dry goods contained therein.

In certain aspects, the base can include a measuring compartment that is rotatably connected about an axis extending transverse to a vertical axis of a container. The base can further include a rotating mechanism for rotating the measuring compartment. In certain other aspects, the base can be operatively connected to a body at the second end, which can include a measuring compartment therein that is rotatably connected to the body about an axis extending transverse to a vertical axis of the container. In such embodiments, the base or the body can include a rotating mechanism configured to rotate the measuring compartment. When in operation, this permits the user to dispense material into the measuring compartment vertically by opening the opening and closing mechanism and dispensing a desired quantity of material. Upon closing the opening and closing mechanism, the user can then rotate the measuring compartment using the rotating mechanism to dispense the material in an axis parallel to the vertical axis of the container. The rotating mechanism can be any mechanism which is capable of rotating the measuring compartment about an axis extending transverse to a vertical axis of the container. The rotating mechanism, in some instances, can be a pin which runs through the measuring compartment in an axis transverse to the vertical axis of the container and which is rotatable by a dial located on the outside of the base. In other instances, the rotating mechanism can include, by example but not limitation, dials, hinges, sprockets, gears, levers, spools, pins and cranks. In another example, the measuring compartment can be operatively connected to the base or body by having a cylindrical end that fits into a similarly-shaped indentation in the base or the body, allowing one side of the measuring compartment to be rotatably connected to the base or the body. On an opposing side of the measuring compartment a dial can be connected which connects to the measuring compartment through the base or the body. In this way, the measuring compartment is rotatably connected to the base or the body and operable by a dial. Rotating mechanisms are well-known to those of skill in the art. In some embodiments, the measuring compartment is operated by rotating means, which allow for rotation of the measuring compartment within the body. Means for rotating the measuring compartment can include, but are not limited to, dials, hinges, sprockets, gears, levers, spools, pins, and cranks.

In some embodiments, at least a portion of the opening and closing mechanism can be positioned within the base and/or at least a portion of the opening and closing mechanism can extend outwardly from the base. In other embodiments, the opening and closing mechanism can be mounted onto the base on either the first end or second end. In still other embodiments, the opening and closing mechanism can be mounted on the body. In certain aspects, at least a portion of the opening and closing mechanism can have a planar shape and/or be larger than the at least one aperture of the base. In certain aspects, the opening and closing mechanism can include a lever extending at least partially outwardly from the base and/or be slideably operated. In certain embodiments, the opening and closing mechanism can be operated using a lever. In certain embodiments, the opening and closing mechanism can be slideably operated. Suitable opening and closing mechanisms include doors, slides, covers and any other means which prevent the flow of material through the at least one aperture when in a first configuration. For example, a slideable cover can be mounted in tracks within the base allowing for the opening and closing of the at least one aperture by sliding the cover. Another example would be a cover mounted on a pivot which can be moved by a lever into a first configuration wherein the at least one aperture is closed and a second configuration wherein the at least one aperture open. In this way, the flow of material through the at least one aperture can be controlled by the opening and closing mechanism. Any suitable mechanism for opening and closing the at least one aperture can be employed. By disposing the opening and closing mechanism within the base, this can prevent the capture of food in the mechanics of the opening and closing mechanism and prevent malfunctions of the device due to interference with the opening and closing mechanism by pieces of the material. For example, if the opening and closing mechanism is mounted on the first end of the base, a material such as corn meal could become trapped between the opening and closing mechanism and the base and prevent smooth operation of the opening and closing mechanism, possibly leading to material loss through the at least one aperture even when the opening and closing mechanism is in a closed position. The opening and closing mechanism can also be configured to provide a seal over the at least one aperture. The opening and closing mechanism can also be configured to provide a seal for any slot, hole or any other opening in the base. The seal can be airtight. An airtight seal would further prevent exposure of the material to the environment. By way of example, and not limitation, a slideable opening and closing mechanism which is operated by sliding a cover into a slot in the base can be configured such that the cover is coated with a rubberized coating to provide a seal around the slot to prevent the intrusion of air and humidity into the base and container. The coating can also beneficially provide improved grip for operating the slideable mechanism. Similarly, a lever or the slot itself can be configured or treated to provide a seal.

In some embodiments the at least one aperture can be covered and uncovered by opening and closing means. Such opening and closing means can include, but are not limited to, covers, lids, caps, screw caps, and doors. Such means can be slideable, pivotable or otherwise movable. Means for covering and uncovering the at least one aperture are known to those of skill in the art.

Covering mechanisms can also include any appropriate mechanism for covering or closing an aperture including, but not limited to, lids, caps, screw caps, snap-on lids, covers, slideable covers and doors. These can be operated by levers or other mechanism and should adequately cover the measuring compartment to isolate it from the base.

In at least some embodiments, the base can be of any appropriate thickness, the thickness being determined based on the weight of the material in the container, the size of the container, the desired durability of the device and other factors. The base can also be configured in any appropriate shape for receiving the container and for dispensing the material. The base can be round at least because many dry goods are packaging in cylindrical containers. The body can also be in any appropriate thickness or shape based on the application. The body can be the same shape as the base, including by way of example but not limitation, a round shape.

In some embodiments the components, including the base, body, measuring compartment and opening and closing mechanism, can be made of any appropriate material. In one embodiment, the material can be plastic. The components can be manufactured by known methods for fabricating parts. In the case of plastics, these methods include, but are not limited to, thermoforming, vacuum-forming, compression molding, injection molding, machining, extrusion and other methods well-known in the art. The material can also be biodegradable or otherwise be made of environmentally friendly materials that have less environmental impact than conventional materials.

Different colors can be used to distinguish materials used with each device. In certain embodiments, the base can be of any desired color. In some embodiments, the body can be of any color. In one embodiment, the body can be at least partially or completely transparent. This permits a person to observe the dispensing of material into the measuring compartment when operating the device. In certain embodiments, the measuring compartment can be of any color. In one embodiment, the measuring compartment is at least partially or completely transparent. This permits a person to observe not only the dispensing of material inside the measuring compartment but to also monitor the quantity of material dispensed, enabling the user to know when to close the opening and closing means to stop the flow of material because a desired quantity has been reached.

In some embodiments, the measuring compartment has at least one volumetric graduation. Such graduations can be marked onto the measuring compartment using methods known in the art including printing, etching and forming of graduations into the material of the measuring compartment. In certain aspects, the volumetric graduations can be printed on or embedded in the measuring compartment. The at least one volumetric graduation permits a user to monitor the dispensing of material into the measuring compartment to accurately measure a desired quantity. The graduation can be a standard measure such a cup, a half cup, a quarter cup, a tablespoon, a teaspoon or any other appropriate increment of volumetric measurement. The graduation can also be a specific quantity that is appropriate for the material to be measured. For example, a serving size of infant formula can be indicated by a line on the measuring compartment.

Devices of the present disclosure can also further include a stand. A stand can permit operation of the device a target container for the material and facilitate operation of the device without the user having to hold the device during use. In certain aspects, the stand can be operatively connected to the body of a device.

In some embodiments, methods are provided for using a measurement device for the measurement and dispensing of dry goods. The dry goods can be any desired dry good such as food products, cleaning products, agricultural products. In certain aspects, the dry goods are selected from the group consisting of corn meal, bread crumbs, cereals, grains, oats, coffee, whey-based protein powder, infant formula powder, other powder-based beverages, grits and spices. Other examples of materials which can be measured and dispensed using devices of the present disclosure are dry fertilizers, flour, dry pesticides, dry herbicides, powdered milk, powdered tea, lime, chalk, and salt.

The devices can be sized appropriately based on the container which the base will receive, the dispensing parameters, material volumes and other factors. The at least one aperture in the base can be of any appropriate size and shape based on the flow characteristics of the material to be measured. The total number of apertures to be used can also be determined based on the flow characteristics of the material to be measured and the desired flow rate of material through the base.

The devices can be sized appropriately to be incorporated with current packaging for dry goods. For example, many dry goods are sold in cylindrical containers of the same diameter. Thus, the devices can be used for goods such as oatmeal, coffee and infant formula. This provides a benefit of a universal design which can be scaled as needed based on container size but which can, for certain products, be consistent across a manufacturer's different products. Thus, cost savings can be enjoyed by using a single size of the device in manufacturing. However, the devices of the present disclosure are designed to be sizable based on the application. For example, many consumer spice containers are smaller than containers for products such as coffee. A similarly designed device of a smaller size can be used for spices, delivering the same measurement and dispensing performance but at an appropriate size for the material container.

In addition, the devices can also be manufactured or sold in separate components. By way of example, a stand, which can be operatively connected to a body to which the measuring compartment is rotatably connected, could be manufactured or marketed as a single, reusable unit. Containers of material operatively connected to a base of devices of the present disclosure could likewise be sold separately from the stand. The base of the device could then be operatively connected by, for example, screwing the base onto the body after inverting the container of material. In this way, the material could be measured through the measuring compartment and, once the material is depleted or a user desires to change the container, the base and body can be detached by, for example, unscrewing the base from the body and another container operatively connected to a base can be inverted and screwed onto the body. This can likewise present cost savings by providing a reusable measuring device which allows for interchange of the material to be measured.

The devices can also be useful in emergency situations such as natural disasters including storms, earthquakes, and flooding. By providing a device for preventing contamination and spoilage of food while also providing for reproducible rationing of materials, devices of the present disclosure are of particular benefit in an emergency situation. A person can pack the device with the attached container and portably and safely transport the material and, when needed, dispense accurate portions of the material reproducibly with minimal waste and risk of contamination or spoilage. By decreasing waste and better preserving the material, devices of the present disclosure allow for improved control over rations and longer use in critical situations where food or other supplies can be scarce and there is a need to carefully ration consumption. In addition, the devices can be prepackaged for emergency preparedness kits so that they can be easily and quickly taken with a person in case of an emergency. For similar reasons, the devices can also be useful for camping and travel.

In addition, in certain embodiments, the devices can be useful as seed incubators after the material in the container is consumed. A person could fill the container with soil or other suitable substrate for growing plants and deposit seeds within the container. By opening the opening and closing mechanism while leaving the measuring compartment attached to the device, provided that light can penetrate the measuring compartment, the device can act as a greenhouse and allow for plant germination. Therefore, the devices can also be more environmentally friendly by having more than one potential use.

In one method for using the devices, the device is operatively connected to a container in an upright position with the opening and closing mechanism in the closed position. The container and device are then inverted and the opening and closing mechanism is placed in the open position to permit the flow of material through the at least one aperture into the measuring compartment. Once the desired quantity of material is delivered to the measuring compartment, the opening and closing mechanism can be placed in the closed position and the measuring compartment can be rotated, if in a rotatable configuration, or the lid can be opened to dispense the material to its destination. In some embodiments, the measuring compartment can be detached from the base to permit dispensing of the material or further transport and storage.

In certain aspects, a method of measuring and dispensing a material is provided. The method includes inverting the base and/or base and body in addition to the container when the opening and closing mechanism is in a first configuration. The at least one aperture can then be opened by moving the opening and closing mechanism to the second configuration, thereby permitting at least some of the material to flow through the at least one aperture and into the measuring compartment. The at least one aperture can then be closed by moving the opening and closing mechanism to the first configuration. In some embodiments, the measuring compartment can then be rotated to dispense the material.

In one embodiment, a method for measuring material can include placing a container onto a base; inverting the combined base and container while the opening and closing mechanism is in the first configuration, opening the at least one aperture by moving the opening and closing mechanism to the second configuration, thereby permitting at least some of the material to flow through the at least one aperture and into the measuring compartment until a desired quantity of material is obtained. The at least one aperture can then be closed by moving the opening and closing mechanism to the first configuration. A lid capable of covering at least one aperture at an end distal from the base can then be removed to dispense the material.

In a particular embodiment, as depicted in FIG. 1, the device can include a base 1 having a first end 2 and an opposing second end 3. The base 1 can have a circular shape when viewed from above or below. The second end 3 of the base 1 can be connected to a body 4 that extends outwardly from the base 1. The base 1 and the body 4 can interact or be formed in any of a variety of ways. For example, the base 1 can be removably attachable to the body 4, or the base 1 can be integrally formed with the body 4. The body 4 can have a cylindrical shape.

The base 1 can include an aperture 5 therein or therethrough, and the base 1 can include an opening and closing mechanism 8. One or both of the aperture 5 and the opening and closing mechanism 8 can be located within the base or proximate to the second end 3 of the base 1. The opening and closing mechanism 8 can be in the form of a cover attached to a lever which protrudes partially through a slot in the base 1.

The opening and closing mechanism 8 can leave the aperture 5 at least partially or completely open or exposed when in an “open” configuration, as depicted in FIG. 1. However, the opening and closing mechanism 8 can be moved by sliding or pivoting a lever 9 mounted on a pivot 10, such that the opening and closing mechanism 8 can cover the aperture 5 so that it is closed. At least a portion of the lever 9 can extend radially outwardly through an opening in a side of the body 1.

The body 4 can include a measuring compartment 6 positioned above the aperture 5. The measuring compartment 6 can be rotatably and/or removably attached to the body 4. The measuring compartment 6 can be rotated or otherwise moved by a rotating mechanism 7. As shown in FIG. 1, the rotating mechanism 7 can be a dial directly connected to the measuring compartment 6.

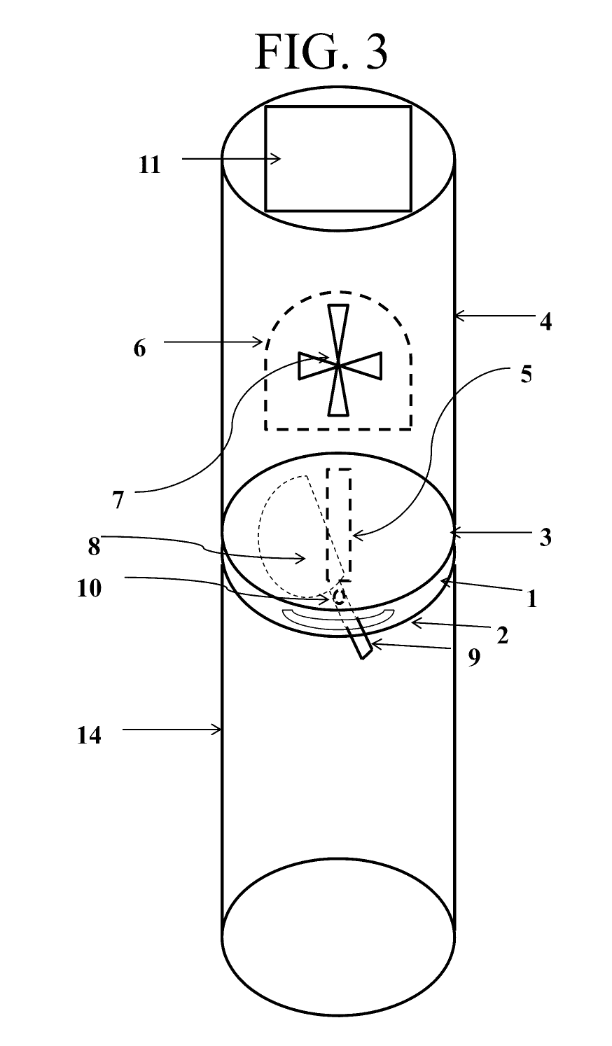

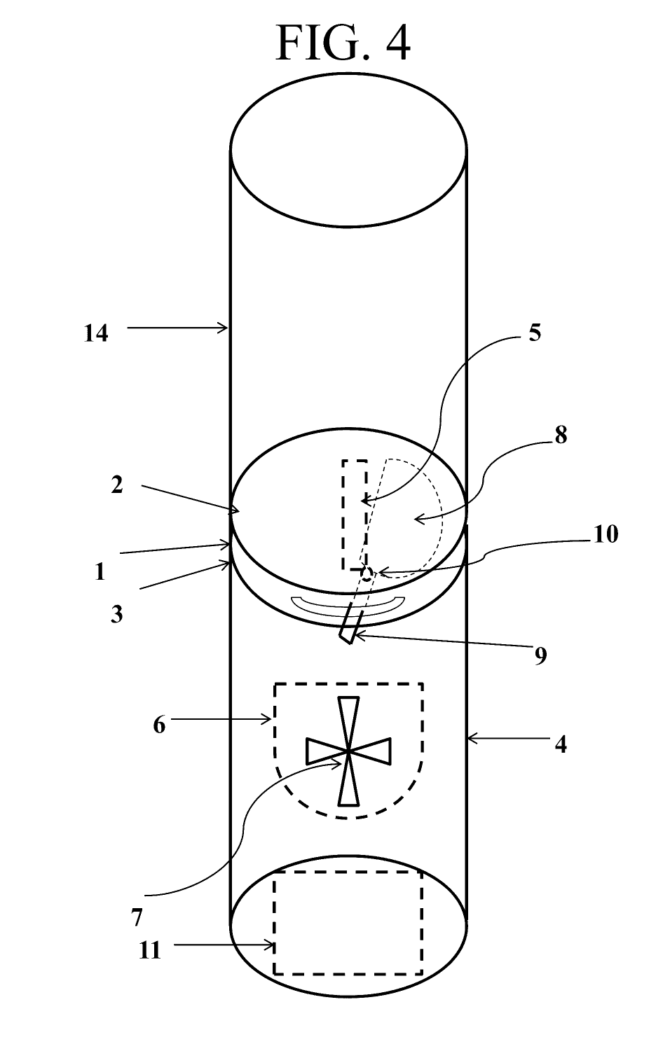

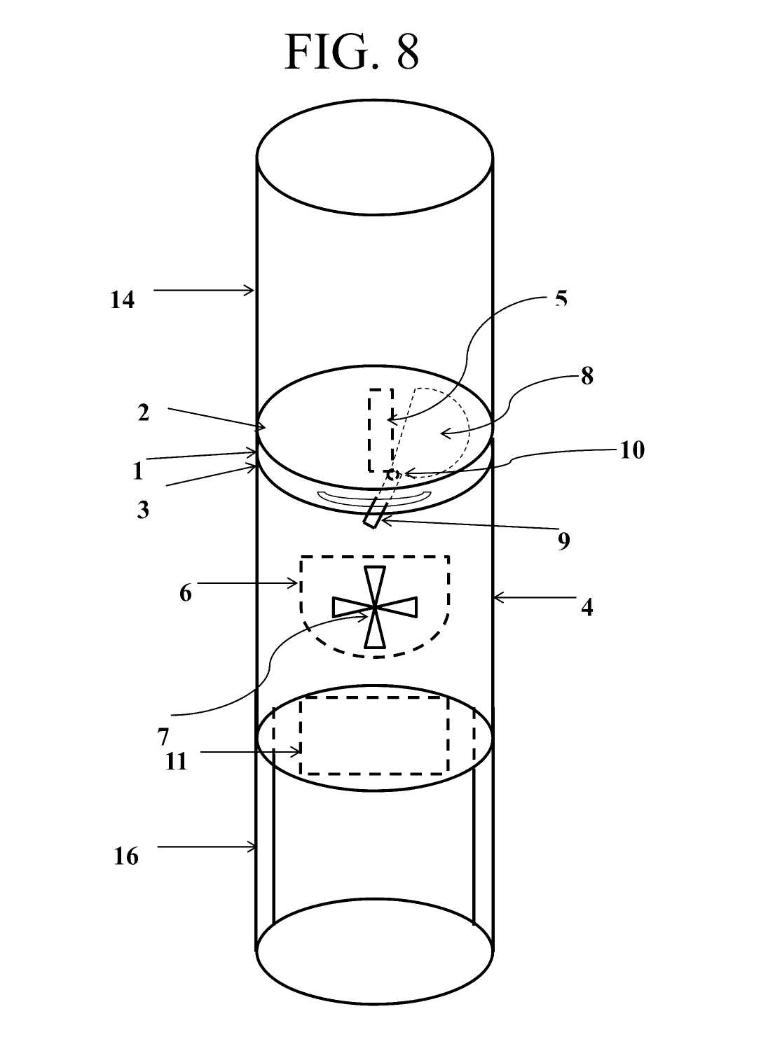

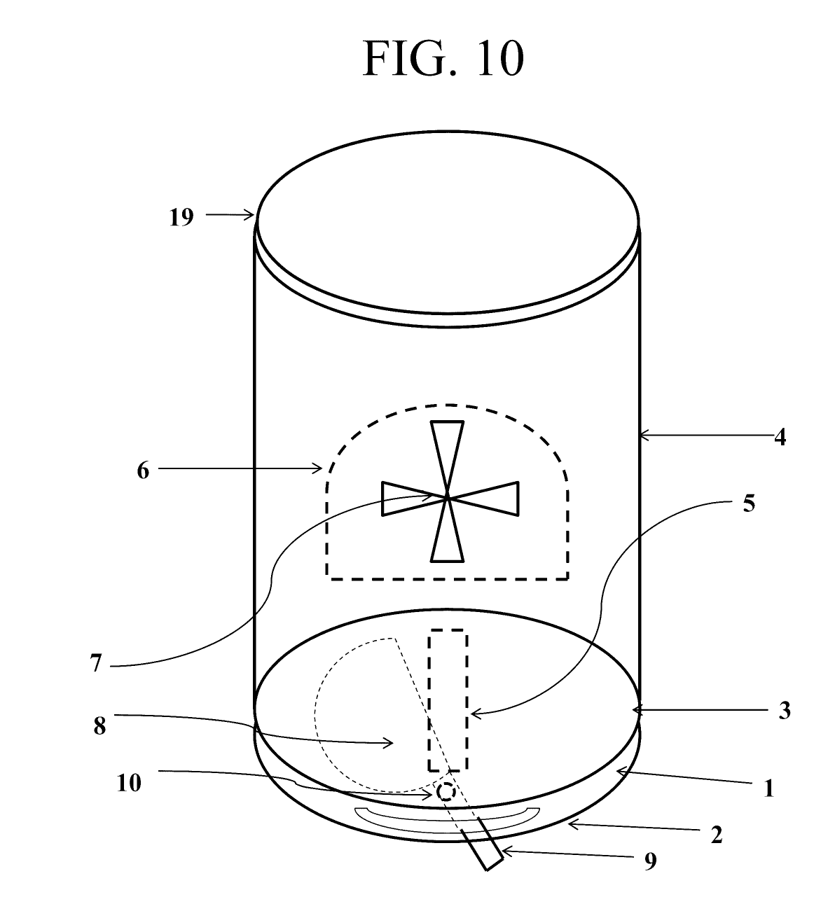

In operation, a container 14, as shown in FIG. 3, housing, for example, infant formula, can be attached to the base 1. An open or top end of the container can be positioned against or attached to the first end 2 of the base 1. The device, with the container, can then be inverted (e.g., 180 degrees) as shown in FIG. 4 to position the device for measuring and dispensing material, such as the infant formula. By opening the aperture 5 using the opening and closing mechanism 8, material can flow from the container 14, through the base 1 and into the measuring compartment 6 of the body 4, where it can be collected until the aperture 5 is closed by moving the opening and closing mechanism 8. Once the opening and closing mechanism 8 is used to close the aperture 5, the measuring compartment 6 can be rotated using the rotating mechanism 7 to dispense the material, such as infant formula, below the device through a chute 11. The measuring compartment 6 can then be rotated back into a position wherein it is open toward the aperture 5 and the process can be repeated. The device can also be placed on a stand 16 as shown in FIG. 8 where the stand is made up of vertical support struts connected to a platform base. The device can also further include a lid 19 which covers the end of the body distal from the base as shown in FIG. 10.

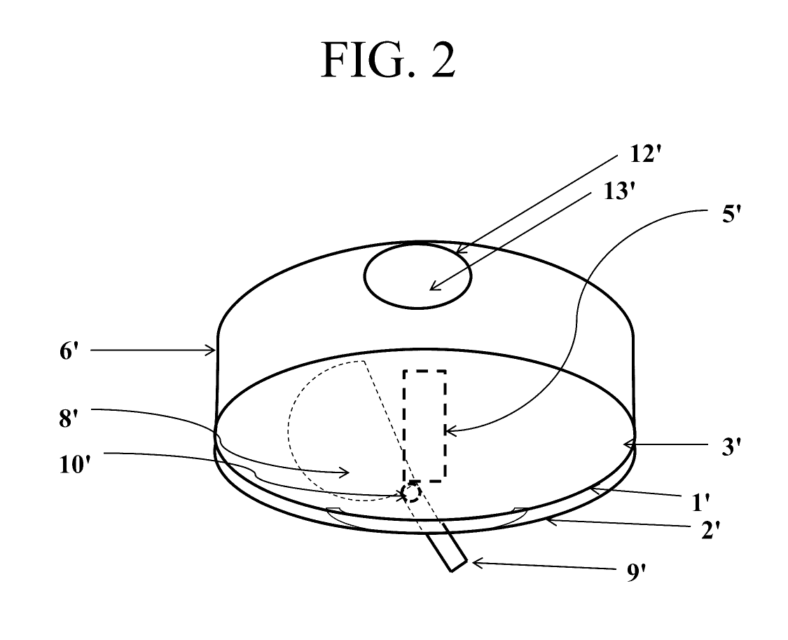

In another embodiment, as depicted in FIG. 2, the device can include a circular base 1′ having both a first end 2′ and a second end 3′. The second end 3′ can be connected to a measuring compartment 6′, which can include an aperture 12′ covered by a lid 13′. The circular base 1′ can further include an aperture 5′ and an opening and closing mechanism 8′ in the form of a cover attached to a lever 9′ which protrudes through a slot in the base 1′. The opening and closing mechanism leaves the aperture 5′ “open” when in the configuration depicted in FIG. 2. However, the cover can be moved by sliding the lever 9′ which is mounted on a pivot 10′ such that the cover of the opening and closing mechanism 8′ covers the aperture 5′ so that it is closed.

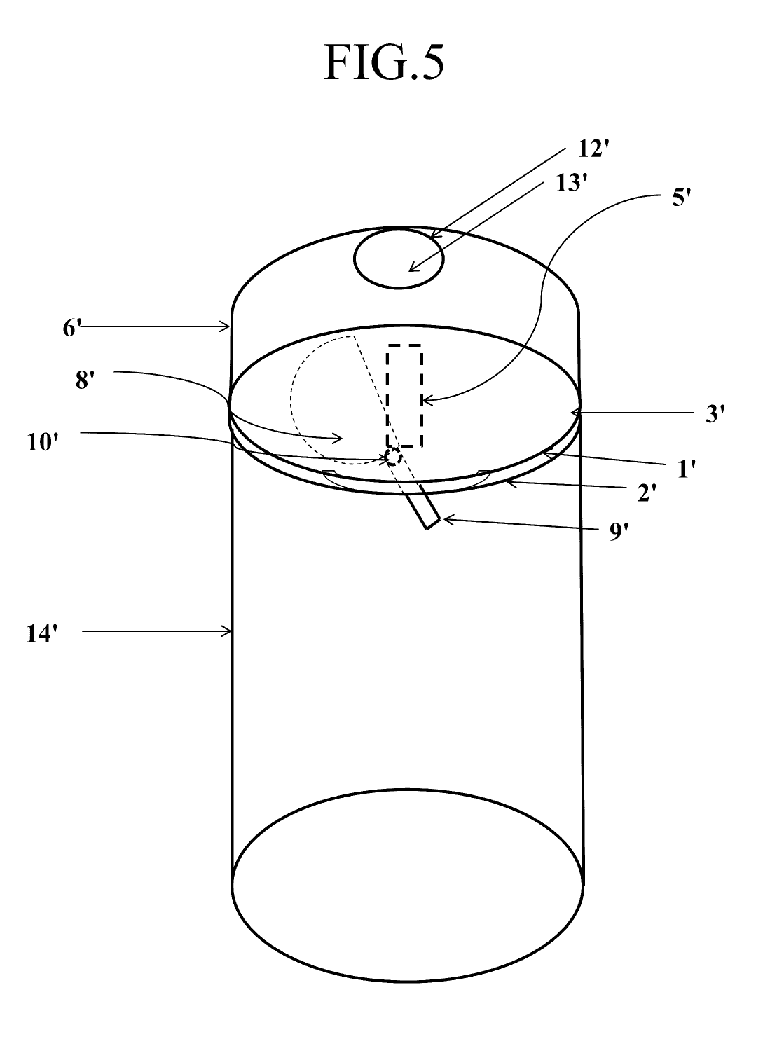

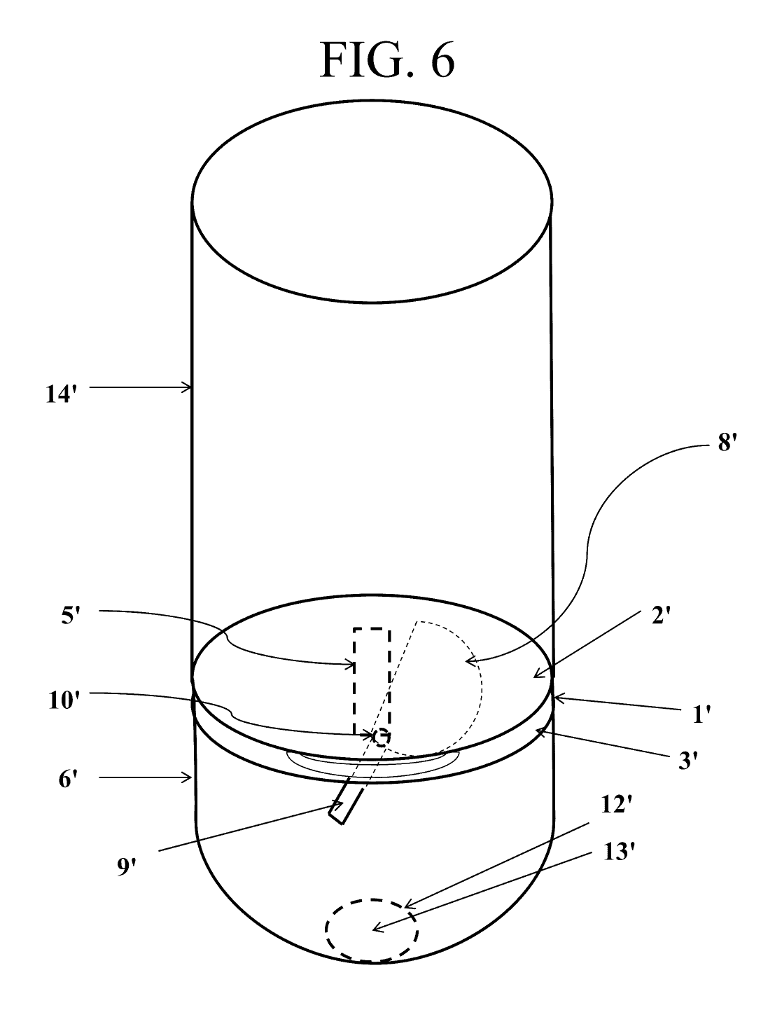

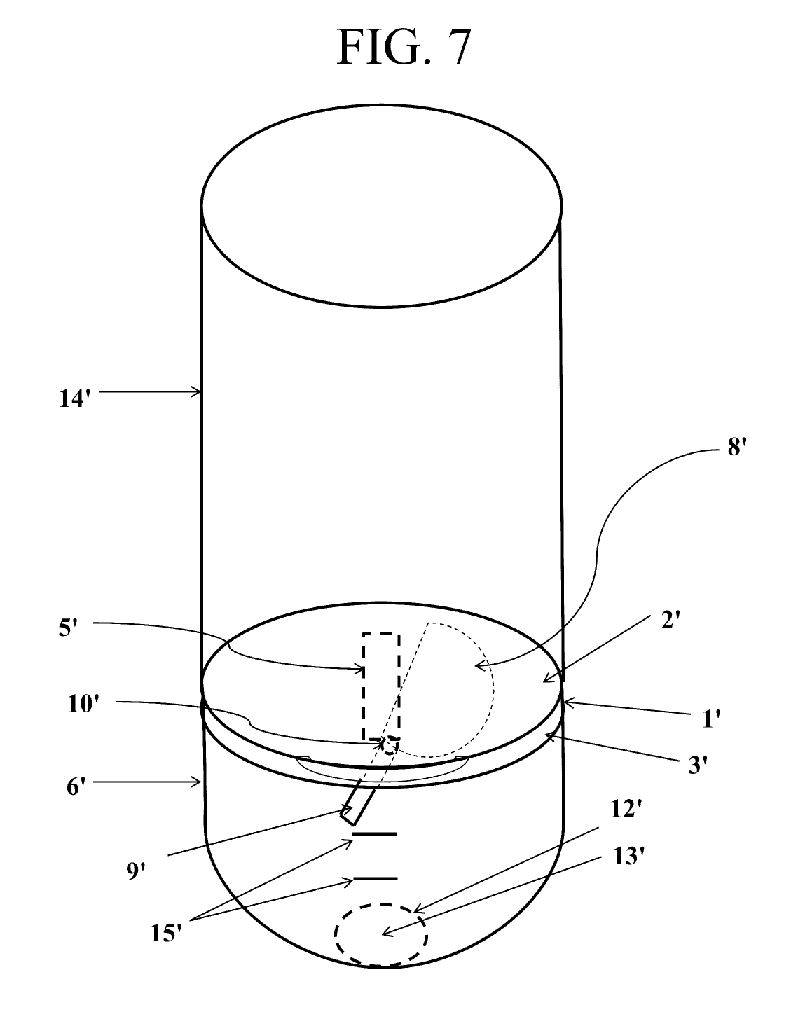

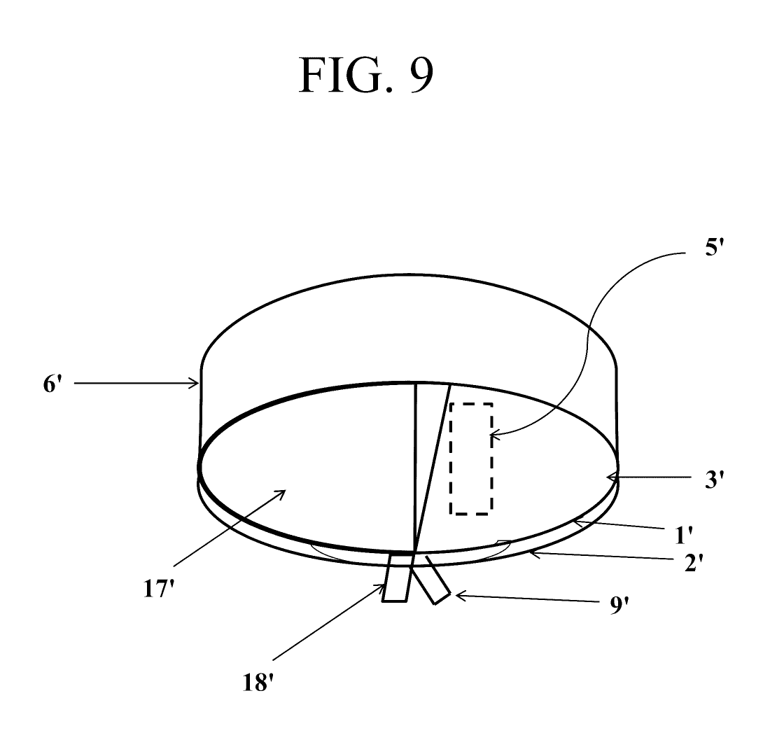

In operation, a container 14′, as shown in FIG. 5, for example, a container of infant formula is attached to the base 1′ with its open end positioned against the first end 2′ of the base 1′. The device, with the container, can then be inverted, as shown in FIG. 6, to operate the device for measuring and dispensing material such as infant formula. By opening the aperture 5′ using the opening and closing mechanism 8′, material can flow from the container through the base into the measuring compartment 6′ where it is collected until the aperture 5′ is closed using the opening and closing mechanism 8′. Once the opening and closing mechanism 8′ is used to close the aperture 5′, the measuring compartment 6′ can be opened by removing the lid 13′ to dispense the material, such as infant formula, through the aperture 12′. The lid 13′ can be replaced and the process repeated as necessary. The device can also include volumetric graduations 15′ on the measuring compartment 6′ as depicted in FIG. 7. Also, a covering mechanism 17′ such as that depicted in FIG. 9 can be used. In FIG. 9, the covering mechanism has two semi-circular portions, one fixed to the measuring compartment and one movable via a lever 18′ which allows for the measuring compartment to be sealed off from the base and container. Once sealed, the measuring compartment 6′ and covering mechanism 17′ can be removed from the base 1′ and used as portable storage for the measured quantity of material.

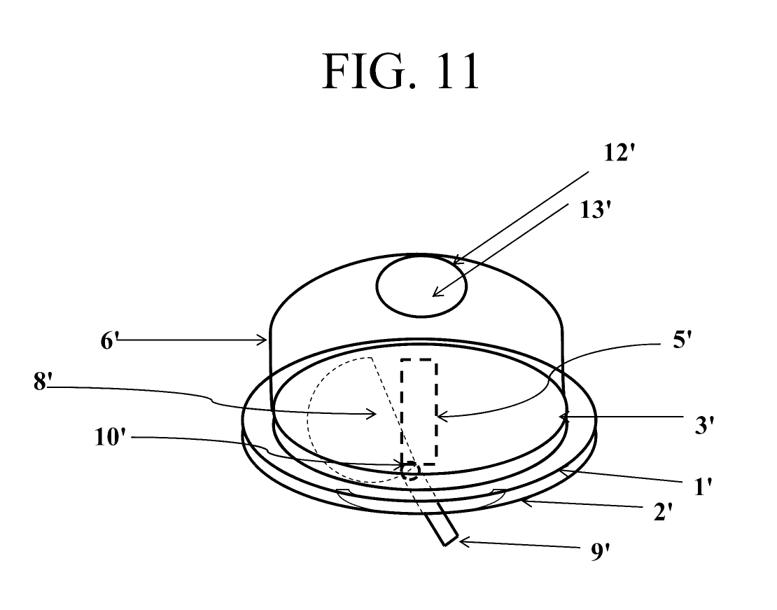

In another embodiment, as depicted in FIG. 11, the device can include a circular base 1′ having both a first end 2′ and a second end 3′. The second end 3′ can be a circular, raised platform that is concentric within the outer diameter of the circular base, and can be connected to a measuring compartment 6′ by snapping the measuring compartment 6′ onto the second end 3′, which can include an aperture 12′ covered by a lid 13′. The circular base 1′ can further include an aperture 5′ and an opening and closing mechanism 8′ in the form of a cover attached to a lever 9′ which protrudes through a slot in the base 1′. The opening and closing mechanism leaves the aperture 5′ “open” when in the configuration depicted in FIG. 11. However, the cover can be moved by sliding the lever 9′ which is mounted on a pivot 10′ such that the cover of the opening and closing mechanism 8′ covers the aperture 5′ so that it is closed.

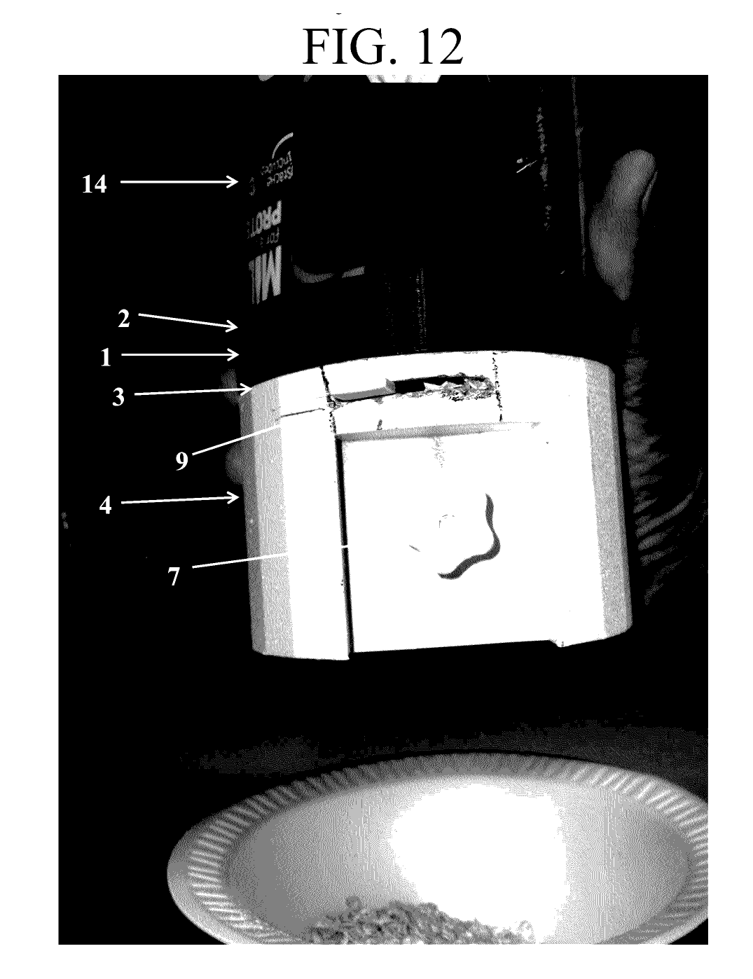

In another embodiment, as depicted in FIG. 12, the device can include a base 1 having a first end 2 and an opposing second end 3. The device can be operatively connected to a container 14 at the first end 2. The base 1 can have a circular shape when viewed from above or below. The second end 3 of the base 1 can be connected to a body 4 that extends outwardly from the base 1. The body 4 can have a cylindrical shape. The base 1 can further include a lever 9 for operating an opening and closing mechanism. A rotating mechanism 7 can be used to rotate the measuring compartment.

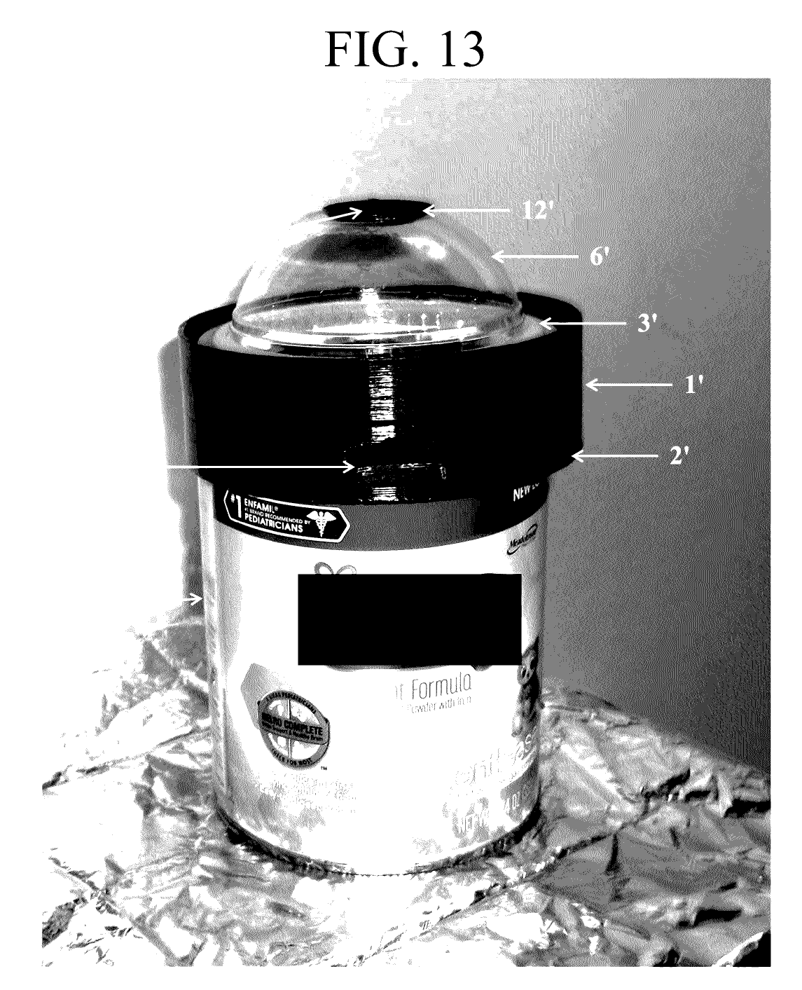

In another embodiment, as depicted in FIG. 13, the device can include a circular base 1′ having both a first end 2′ and a second end 3′. A container 14′ can be connected to the first end of the device. The second end 3′ can be connected to a measuring compartment 6′, which can include an aperture 12′ covered by a lid 13′. The circular base 1′ can further include an aperture and an opening and closing mechanism in the form of a cover attached to a lever 9′ which protrudes through a slot in the base 1′. The cover can be moved by sliding the lever 9′ which is slideable such that the cover of the opening and closing mechanism covers the aperture so that it is closed.

In yet another embodiment, as depicted in FIG. 14, the device can include a base 1 having a first end 2 and an opposing second end 3. The base 1 can have a circular shape when viewed from above or below. The base 1 can further include an aperture 5 and an opening and closing mechanism 8. One or both of the aperture 5 and the opening and closing mechanism 8 can be located within the base 1. The opening and closing mechanism 8 can be in the form of a cover attached to a lever which protrudes through a slot in the base 1 and operates on a pivot 10. The rotating mechanism 7 is configured to rotate the measuring compartment 6 which is rotatably connected to the base 1. Material which is dispensed can be dispensed through the chute 11.

### EXAMPLES

To facilitate a better understanding of the present disclsore, the following examples of specific devices and methods are given. In no way should the following examples be read to limit or define the entire scope of the disclsoure.

### Example 1

### Measuring and Dispensing Oatmeal

A device of the present invention as depicted in FIG. 1 was used to measure oatmeal into a bowl. The base was configured with a single aperture and opening and an opening and closing mechanism including a cover operated by sliding a lever protruding from the base as shown in FIG. 1. The base was round in shape and made of a suitable diameter for the oatmeal container (6¼″). The measuring compartment had a volume of one cup and the rotating mechanism was a dial which was mounted on the body and capable of rotating the measuring compartment via direct attachment through the body of the dial to the measuring compartment. A commercially available brand of oatmeal in a cylindrical container was used.

The container of oatmeal was opened and the lid and lidding material discarded. The device was mounted onto the open container with the first end of the base contacting the open end of the oatmeal container. The device was secured to the oatmeal container using adhesive. Initially, the opening and closing mechanism was kept in the closed position and the measuring compartment was rotated such that it was open toward the container.

The device with the attached container was inverted followed by opening the aperture by sliding the lever for the opening and closing mechanism into the open position, allowing oatmeal to flow through the aperture into the measuring compartment. After a suitable quantity of oatmeal had been delivered to the container, the aperture was closed using the opening and closing mechanism by sliding the lever to the closed position. The measurement container was then rotated using the dial to dispense the oatmeal into a bowl located under the device.

As can be observed from the foregoing example, the material, in this case oatmeal, was not exposed to the environment during the measurement and dispensing steps. Furthermore, the quantity of oatmeal was able to be measured and dispensed accurately and reproducibly. Aside from the initial opening of the oatmeal container, a step which would be eliminated if the device were mounted on the container upon manufacturing, the oatmeal was protected in a closed container throughout the process with minimal exposure to air and humidity. It is envisioned that the devices of the present invention could be pre-mounted on containers of material and additional means for opening a seal or other barrier could be incorporated such that the material is preserved until the first use but is never fully open to the air and environment except through the device and then only during the measurement steps which are performed in an inverted state wherein contaminants are not introduced into the material through contact from, for example, a scoop nor from air and other contaminants falling into the container. In addition, the material is exposed for a minimal amount of time to moisture and humidity further preventing spoilage of the material.

### Example 2

### Measuring and Dispensing Cornmeal

A device as depicted in FIG. 2 was used to measure cornmeal into a bowl. The base was configured with a single aperture and opening and an opening and closing mechanism including a cover operated by sliding a lever protruding from the base as shown in FIG. 2. The base was round in shape and made of a suitable diameter for the cornmeal container (4¼″). The measuring compartment was dome-shaped and transparent and had a volume of one cup with graduations at ¼ cup, ½ cup and 1 cup and was secured to the base using adhesive. The measuring compartment also had an aperture at the apex of the dome which was covered using an detachably adhesive lid. A commercially available brand of cornmeal in a cylindrical container was used.

The container of cornmeal was opened and the lid and lidding material discarded. The device was mounted onto the open container with the first end of the base contacting the open end of the cornmeal container. The device was secured to the cornmeal container using adhesive. Initially, the opening and closing mechanism was kept in the closed position.

The device with the attached container was inverted followed by opening the aperture by sliding the lever for the opening and closing mechanism into the open position, allowing cornmeal to flow through the aperture into the measuring compartment. After a suitable quantity of cornmeal—¼ cup—had been delivered to the container, the aperture was closed using the opening and closing mechanism by sliding the lever to the closed position. The device was then held above a bowl and the detachable lid removed to allow cornmeal to flow into the bowl.

Similar to the benefits observed in Example 1, it is evident from the present example that exposure of the cornmeal to the environment is minimized by the device and process and the exposure of the cornmeal to contaminants is likewise minimized. In addition, the cornmeal is accurately and reproducibly measured for use. Due to the limited exposure of the cornmeal to environmental factors, spoilage is further prevented.

### Example 3

### Measuring and Dispensing Spices

A device of the present invention as depicted in FIG. 2 was used to measure crushed red pepper flakes into a bowl. The base was configured with a single aperture and opening and an opening and closing mechanism including a cover operated by sliding a lever protruding from the base as shown in FIG. 2. The base was round in shape and made of a suitable diameter for the crushed red pepper flakes container (1¾″). The measuring compartment was dome-shaped and transparent and was secured to the base using adhesive. The measuring compartment also had an aperture at the apex of the dome which was covered using an detachably adhesive lid. A commercially available brand of crushed red pepper flakes in a cylindrical container was used.

The container of crushed red pepper flakes was opened and the lid and lidding material discarded. The device was mounted onto the open container with the first end of the base contacting the open end of the crushed red pepper flakes container. The device was secured to the crushed red pepper flakes container using adhesive. Initially, the opening and closing mechanism was kept in the closed position.

The device with the attached container was inverted followed by opening the aperture by sliding the lever for the opening and closing mechanism into the open position, allowing crushed red pepper flakes to flow through the aperture into the measuring compartment. After a suitable quantity of crushed red pepper flakes had been delivered to the container, the aperture was closed using the opening and closing mechanism by sliding the lever to the closed position. The device was then held above a bowl and the detachable lid removed to allow crushed red pepper flakes to flow into the bowl.

Similar to the benefits observed in Examples 1 and 2, it is evident from the present example that exposure of the crushed red pepper flakes to the environment is minimized by the device and process and the exposure of the crushed red pepper flakes to contaminants is likewise minimized. In addition, the crushed red pepper flakes are accurately and reproducibly measured for use. Due to the limited exposure of the crushed red pepper flakes to environmental factors, spoilage is further prevented.

### Example 4

### Measuring and Dispensing of Dry Plant Food

A device of the present invention as depicted in FIG. 1 could be used to measure dry plant food. The base would be configured with a single aperture and opening and an opening and closing mechanism including a cover operated by sliding a lever protruding from the base as shown in FIG. 1. The base would be rectangular in shape to accommodate the container of dry plant food if it is rectangular in shape. The body would be transparent to enable viewing of the dispensing process. The measuring compartment could be sized for a single unit—i.e. the amount of plant food for a gallon of water—of the dry plant food. The rotating mechanism could be a dial which is mounted on the body and capable of rotating the measuring compartment via direct attachment through the body of the dial to the measuring compartment.

The container could be sold with the device pre-attached. The device would be mounted onto the open container with the first end of the base contacting the open end of the dry plant food container. The device could be secured to the container using adhesive. Initially, the opening and closing mechanism would kept in the closed position and the measuring compartment would be rotated such that it was open toward the container.

The device with the attached container would then be inverted followed by opening the aperture by sliding the lever for the opening and closing mechanism into the open position, allowing dry plant food to flow through the aperture into the measuring compartment. After a suitable quantity of dry plant food, as observed through the transparent body, had been delivered to the measuring compartment, the aperture would be closed using the opening and closing mechanism by sliding the lever to the closed position. The measurement container would then be rotated using the dial to dispense the dry plant food into a bucket or other receptacle located under the device.

As can be observed from the foregoing example, the material, in this case dry plant food, would not be exposed to the environment during the measurement and dispensing steps. Furthermore, the quantity of dry plant food would be able to be measured and dispensed accurately and reproducibly. In order to maintain freshness of the dry plant food and prevent tampering, the opening and closing mechanism could be secured such that a seal would be broken upon the first use. The seal could be to secure the opening and closing mechanism to the device and/or could open an inner seal which is mounted on the container to seal the dry plant food inside. The dry plant food would be protected in a closed container throughout the process with minimal exposure to air and humidity. In addition, the dry plant food would exposed for a minimal amount of time to moisture and humidity further preventing spoilage of the dry plant food.

### Example 5

### Measuring and Dispensing of Paint

A device as depicted in FIG. 1 could be used to measure paint. The base would be configured with a single aperture and opening and an opening and closing mechanism including a cover operated by sliding a lever protruding from the base as shown in FIG. 1. The base would be round in shape to accommodate the container of paint. The body would be transparent to enable viewing of the dispensing process. The measuring compartment could be sized for a specific volume such as a volumetric cup. The base, opening and closing mechanism, body and measuring compartment could be made from a material to which the paint would not adhere to enable flow of the paint through the device and avoid deposition of the paint which could contaminate later dispensing of the paint. The rotating mechanism could be a dial which is mounted on the body and capable of rotating the measuring compartment via direct attachment through the body of the dial to the measuring compartment.

The paint container could be sold with the device pre-attached. The device would be mounted onto the open container with the first end of the base contacting the open end of the paint container. The device could be secured to the container using adhesive or attached using a screw-type mechanism or clamps, clasps or other attachment devices. Initially, the opening and closing mechanism would kept in the closed position and the measuring compartment would be rotated such that it would be open toward the container.

The device with the attached container would then be inverted and could be placed on a stand configured to hold the container and device stably in the invented position, followed by opening the aperture by sliding the lever for the opening and closing mechanism into the open position, allowing paint to flow through the aperture into the measuring compartment. After a suitable quantity of paint, as observed through the transparent body, had been delivered to the measuring compartment, the aperture would be closed using the opening and closing mechanism by sliding the lever to the closed position. The measurement container would then be rotated using the dial to dispense the paint into a bucket or other receptacle, for example, a paint tray located under the device.

As can be observed from the foregoing example, the material, in this case paint, would not be exposed to the environment during the measurement and dispensing steps. Furthermore, the quantity of paint would be able to be measured and dispensed accurately and reproducibly. In order to prevent leakage from the container and/or device, a seal could be incorporated around the opening and closing mechanism. The paint would be protected in a closed container throughout the process with minimal exposure to air and humidity. In addition, the paint would be exposed for a minimal amount of time to moisture and humidity further preventing spoilage of the paint.

### Example 6

### Measuring and Dispensing Ice Tea Mix

A device as depicted in FIG. 14 was used to measure powdered ice tea mix into a bowl. The base was configured with a single aperture and opening and an opening and closing mechanism including a cover operated by sliding a lever protruding from the base as shown in FIG. 14. The base was round in shape and made of a suitable diameter for the whey powder container (6¼″). The measuring compartment had a volume of one cup and the rotating mechanism was a dial which was mounted on the base and capable of rotating the measuring compartment via direct attachment through the base of the dial to the measuring compartment. A commercially available brand of powdered ice tea mix in a cylindrical container was used.

The container of powdered ice tea mix was opened and the lid and lidding material discarded. The device was mounted onto the open container with the first end of the base contacting the open end of the oatmeal container. The device was secured to the powdered ice tea container using adhesive. Initially, the opening and closing mechanism was kept in the closed position and the measuring compartment was rotated such that it was open toward the container.

The device with the attached container was inverted followed by opening the aperture by sliding the lever for the opening and closing mechanism into the open position, allowing powdered ice tea mix to flow through the aperture into the measuring compartment. After a suitable quantity of powdered ice tea mix had been delivered to the container, the aperture was closed using the opening and closing mechanism by sliding the lever to the closed position. The measurement container was then rotated using the dial to dispense the powdered ice tea mix into a cup located under the device.

As can be observed from the foregoing example, the material, in this case powdered ice tea mix, was not exposed to the environment during the measurement and dispensing steps. Furthermore, the quantity of powdered ice tea mix was able to be measured and dispensed accurately and reproducibly. Aside from the initial opening of the powdered ice tea mix container, a step which would be eliminated if the device were mounted on the container upon manufacturing, the powdered ice tea mix was protected in a closed container throughout the process with minimal exposure to air and humidity. It is envisioned that the devices of the present invention could be pre-mounted on containers of material and additional means for opening a seal or other barrier could be incorporated such that the material is preserved until the first use but is never fully open to the air and environment except through the device and then only during the measurement steps which are performed in an inverted state wherein contaminants are not introduced into the material through contact from, for example, a scoop nor from air and other contaminants falling into the container. In addition, the material is exposed for a minimal amount of time to moisture and humidity further preventing spoilage of the material.

Therefore, the present invention is well adapted to attain the ends and advantages mentioned as well as those that are inherent therein. While numerous changes can be made by those skilled in the art, such changes are encompassed within the spirit of this invention as illustrated, in part, by the appended claims.

What is claimed is:

1. A measurement device comprising:
a base including a first end, an opposing second end, at least one aperture, and a rotating mechanism, the first end of the base being configured to contact at least a portion of a container;
a measuring compartment rotatably connected to the base about an axis extending transverse to a vertical axis of the container, the rotating mechanism being configured to rotate the measuring compartment; and
an opening and closing mechanism operatively connected to the base, at least a portion of the opening and closing mechanism positioned within the base, at least a portion of the opening and closing mechanism extending outwardly from the base, the opening and closing mechanism closing the at least one aperture in a first configuration and opening the at least one aperture in a second configuration.

2. The measurement device of claim 1, wherein at least a portion of the opening and closing mechanism has a planar shape, and wherein at least a portion of the opening and closing mechanism is larger than the at least one aperture of the base.

3. The measurement device of claim 1, wherein the opening and closing mechanism includes a lever extending at least partially outwardly from the base.

4. The measurement device of claim 1, wherein the opening and closing mechanism is slideably operated.

5. The measurement device of claim 1, wherein the base is at least partially transparent, and wherein said measuring compartment is at least partially transparent.

6. The measurement device of claim 5, wherein the measuring compartment includes volumetric graduations printed thereon or embedded therein.

7. The measurement device of claim 1, further comprising a stand, wherein the base is removably attachable to the stand.

8. A method of measuring and dispensing a material using the device of claim 1, the method comprising:
inverting the base and the container when the opening and closing mechanism is in the first configuration;
opening the at least one aperture by moving the opening and closing mechanism to the second configuration, thereby permitting at least some of the material to flow through the at least one aperture and into the measuring compartment;
closing the at least one aperture by moving the opening and closing mechanism to the first configuration; and
rotating the measuring compartment to dispense the material.

9. The method of claim 8, wherein the material is selected from the group consisting of corn meal, bread crumbs, cereals, grains, oats, coffee, whey-based protein powder, infant formula powder, other powder-based beverages, grits, and spices.

10. A measurement device comprising:
a container including material therein;
a base including a first end, an opposing second end, and at least one aperture extending therethrough, the first end of the base being configured to receive the container;
a body comprising a measuring compartment and a rotating mechanism, at least a portion of the body contacting at least the second end of the base, the rotating mechanism being configured to rotate the measuring compartment along an axis transverse to a vertical axis of the container; and
an opening and closing mechanism operatively connected to the base, the opening and closing mechanism closing the at least one aperture in a first configuration and opening the at least one aperture in a second configuration.

11. The measurement device of claim 10, wherein the body is at least partially transparent, the measuring compartment is at least partially transparent, and the measuring compartment included volumetric graduations printed thereon or embedded therein.

12. The measuring device of claim 10, wherein the opening and closing mechanism includes a lever extending at least partially outwardly from the base.

13. A method of measuring materials using the device of claim 10, the method comprising:
inverting the base and the container when the opening and closing mechanism is in the first configuration;
opening the at least one aperture by moving the opening and closing mechanism to the second configuration; thereby permitting at least some of the material to flow through the at least one aperture and into the measuring compartment;
closing the at least one aperture by moving the opening and closing mechanism to the first configuration; and
rotating the measuring compartment to dispense the material.

14. A measurement device comprising:
a base including a first end and an opposing second end, the base being configured to receive a container at the first end, the base being operatively connected to a measuring compartment at the second end, the base further including at least one aperture; and
an opening and closing mechanism operatively connected to the base, the opening and closing mechanism closing the at least one aperture in a first configuration and opening the at least one aperture in a second configuration.

15. The measurement device of claim 14, further comprising a container operatively connected to the first end of the base.

16. The measurement device of claim 14, wherein the measuring compartment is at least partially transparent and includes volumetric graduations printed thereon or embedded therein.

17. The measurement device of claim 14, wherein the measuring compartment further comprises at least one aperture at an end distal from said base.

18. The measurement device of claim 14, wherein said measuring compartment further comprises a lid capable of covering said at least one aperture at an end distal from said base.

19. The measurement device of claim 14, further comprising a covering mechanism that is operatively connected to the measuring compartment for sealing said measuring compartment from the base, and wherein the measuring compartment and covering mechanism are detachable from the base.

20. A method for measuring material using the measurement device of claim 18, the method comprising:
placing a container onto a base;
inverting the combined base and container while the opening and closing mechanism of the base is in the first configuration;
opening the at least one aperture of the base by moving the opening and closing mechanism to the second configuration, thereby permitting at least some of the material to flow through the at least one aperture and into the measuring compartment until a desired quantity of material is obtained;
closing the at least one aperture by moving the opening and closing mechanism to the first configuration; and
opening the lid capable of covering said at least one aperture at an end distal from said base to dispense the material.
